(19) United States
(12) Patent Application Publication
(10) Pub. No.: US 2013/0282869 A1
(43) Pub. Date: Oct. 24, 2013

(54) METHOD, APPARATUS, AND COMPUTER PROGRAM PRODUCT FOR SCHEDULING FILE UPLOADS

(71) Applicants: Sujeet Shyamsundar Mate, Tampere (FI); Igor Danilo Diego Curcio, Tampere (FI); Priyaranjan Singh, Tampere (FI)

(72) Inventors: Sujeet Shyamsundar Mate, Tampere (FI); Igor Danilo Diego Curcio, Tampere (FI); Priyaranjan Singh, Tampere (FI)

(73) Assignee: NOKIA CORPORATION, Espoo (FI)

(21) Appl. No.: 13/454,923

(22) Filed: Apr. 24, 2012

(51) Int. Cl. G06F 15/16

(52) U.S. Cl. 709/219

(57) ABSTRACT

A method, apparatus and computer program product for scheduling file uploads are provided. A request may be received to upload a file and, utilizing any of personal preferences, position data, network access point data and power consumption data, a time to begin the file upload and/or a network access point(s) by which to upload the file may be scheduled. The scheduling may comprise calculating a suitability score for a network access point(s).

### TECHNOLOGICAL FIELD

An example embodiment of the present invention relates generally to uploading files and, more particularly, to a method, apparatus and computer program product for scheduling the time at which an upload begins and/or a network access point(s) by which a file is uploaded.

### BACKGROUND

The widespread use of social media applications has led to an increase in sharing of large media files, such as video and audio files. In addition, improved mobile technology allows for larger amounts of digital content to be captured and stored, thus creating an increase in demand for uploading such digital content from mobile devices to social media sites or other applications and services. Similarly, improvements in mobile technology have allowed for capturing better quality content, such as, for example, high definition video, but may result in an increase in file size when compared to lower quality media files.

The uploading of large files from mobile devices may create various challenges. Variable signal strength may interrupt a file upload, and insufficient bandwidth may lead to lengthy upload times, therefore additionally straining battery power of the mobile device. Furthermore, some users may incur costly charges associated with wireless data usage. Additionally, some users may experience diminished performance from other applications or mobile device features while waiting for a file to upload.

### BRIEF SUMMARY

A method, apparatus, and computer program product are therefore provided for scheduling an upload start time and/or a network access point by which a file is uploaded. An example embodiment provided herein may provide efficient scheduling of uploads and therefore may reduce power usage. In this regard, some efficiency may be gained when an example embodiment is implemented on a mobile device, such as those on which battery conservation is particularly important. However, it should be appreciated that embodiments implemented on other types of apparatuses may also realize the benefits described herein. In this regard, it should be appreciated that mobile device implementations are merely used as an example embodiment, and are not intended to be limiting. In addition to leading to reduced power consumption, some embodiments may schedule an upload to occur at a later time or by a specific access point that will minimize or otherwise reduce the effect on other applications or features.

In a first example embodiment, a method is provided for receiving a request to upload a file, calculating a suitability score associated with at least one access point, and scheduling an upload start time and/or the access point(s) by which to upload the file. In some embodiments, the method may additionally comprise receiving an indication of personal preferences (including but not limited to customizable application-specific preferences) regarding the scheduling and utilizing the preferences during scheduling. In another embodiment, the method may comprise receiving position data, and may base the scheduling at least partially on the position data. Additionally, or alternatively, in other embodiments, the method may comprise receiving access point data, power consumption data and/or processor usage data to determine scheduling. In some embodiments, the scheduling may comprise delaying the upload start time until receipt of an indication of direct connection by wire line to an external device.

In some embodiments, an apparatus is provided, comprising at least one processor and at least one memory including computer program code that may be configured to cause the apparatus to receive a request to upload a file, calculate a suitability score associated with an access point, and schedule an upload start time and/or access point by which to upload the file. In some embodiments the apparatus may receive any of personal preferences, position data, access point data, power consumption data, processor usage data, or indication of direct connection to a device in order to determine scheduling.

In some example embodiments, a computer program product is provided, comprising at least one non-transitory computer readable storage medium having computer-executable program code instructions comprising program code instructions to receive an upload request, calculate a suitability score associated with an access point, and schedule the start time of the upload and/or access point by which to upload the file. In some embodiments, the program code instructions may receive any of personal preferences, position data, access point data, power consumption data, Processor usage data, or indication of direct connection to a device in order to determining scheduling.

### BRIEF DESCRIPTION OF THE DRAWINGS

Having thus described certain example embodiments of the present invention in general terms, reference will hereinafter be made to the accompanying drawings which are not necessarily drawn to scale, and wherein:

FIG. 1 is a block diagram of a system according to example embodiments of the present invention;

FIG. 2 is a block diagram of an apparatus that may be configured to implement example embodiments of the present invention; and

FIG. 3 is a flowchart illustrating operations to schedule a file upload performed in accordance with one embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory or physical storage medium (e.g., volatile or non-volatile memory device), may be differentiated from a “computer-readable transmission medium,” which refers to an electromagnetic signal.

As described below, a method, apparatus and computer program product are provided for scheduling a file upload start time and/or access point(s) by which to upload a file. In this regard, the method, apparatus and computer program product of an example embodiment may analyze various data and information to determine a suitability score for available access points, and schedule the upload to occur via a suitable access point and at a reasonably optimal time.

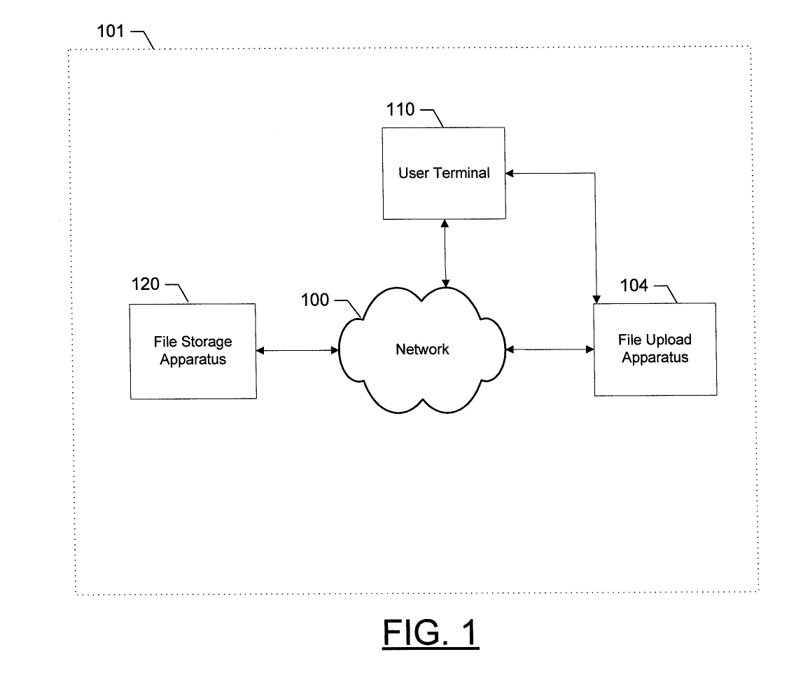

FIG. 1 illustrates a system 101 for scheduling file uploads according to some example embodiments. It will be appreciated that the system 101 as well as the illustrations in other figures are each provided as an example of an embodiment(s) and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for scheduling file uploads, numerous other configurations may also be used to implement embodiments of the present invention.

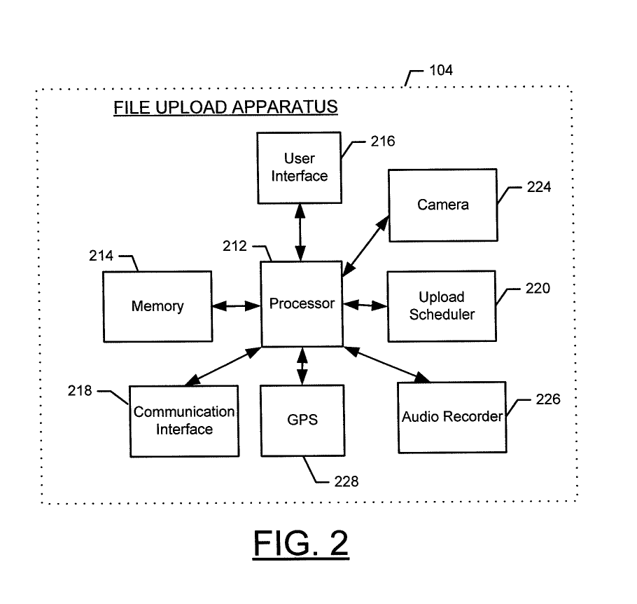

Referring now to FIG. 1, system 101 may include a file upload apparatus 104. File upload apparatus 104 may be embodied by a wide variety of devices including mobile terminals, such as personal digital assistants (PDAs), mobile telephones, gaming devices, laptop computers, tablet computers, cameras, camera phones, video recorders, audio/video players, radios, global position system (GPS) devices, navigation devices, or any combination of the aforementioned, and other types of communications devices. The file upload apparatus 104 need not necessarily be embodied by a mobile device and, instead, may be embodied in a fixed device, such as a computer or workstation. File upload apparatus 104 will be described in further detail, with respect to FIG. 2, hereinafter.

File upload apparatus 104 may connect to a network 100 by which to upload files to a file storage apparatus 120. File upload apparatus 104 may be implemented as a distributed system or a cloud based entity. In this regard, the file upload apparatus 104 may upload files to a server(s), database, memory, and/or the like, incorporated within or otherwise associated with the file storage apparatus 120. In some embodiments, file storage apparatus 120 may be a third party system, such as, for example, a social networking website, email server, or file sharing system. Additionally or alternatively, file upload apparatus 104 may be a mobile device, user terminal, and/or the like. Regardless of implementation and ownership, it will be appreciated that any type of apparatus capable of receiving uploaded files, either by direct connection or a network 100, may be considered a file storage apparatus 120.

Network 100 may be embodied in a local area network, the Internet, any other form of a network, or in any combination thereof, including proprietary private and semi-private networks and public networks. The network 100 may comprise a wire line network, wireless network (e.g., a cellular network, wireless local area network, wireless wide area network, some combination thereof, or the like), or a combination thereof, and in some example embodiments comprises at least a portion of the Internet. As another example, a file upload apparatus 104 may be directly coupled to the file storage apparatus 120, and files may be uploaded from a file upload apparatus 104 to the file storage apparatus 120 via a direct connection.

System 101 may optionally comprise a user terminal 110, which may, for example, be embodied as a laptop computer, tablet computer, desktop computer, workstation, or other like computing device. User terminal 110 may comprise a direct connection, or connection via network 100, to file upload apparatus 104. In this regard, user terminal 110 may serve as an intermediary file storage location to which file upload apparatus 104 may upload files, for subsequent uploading to file storage apparatus 120. In some embodiments, file upload apparatus 104 may be implemented, wholly or partially, on user terminal 110.

Continuing to FIG. 2, file upload apparatus 104 may comprise a processor 212 and memory 214. In some embodiments, the processor 212 (and/or co-processors or any other processing circuitry assisting or otherwise associated with the processor 212) may be in communication with the memory device 214 via a bus for passing information among components of the file upload apparatus 104. The memory device 214 may include, for example, one or more volatile and/or non-volatile memories. In other words, for example, the memory device 214 may be an electronic storage device (e.g., a computer readable storage medium) comprising gates configured to store data (e.g., bits) that may be retrievable by a machine (e.g., a computing device like the processor 212). The memory device 214 may be configured to store information, data, content, applications, instructions, or the like for enabling the apparatus to carry out various functions in accordance with an example embodiment of the present invention. For example, the memory device 214 may be configured to buffer input data for processing by the processor 212. Additionally or alternatively, the memory device 214 may be configured to store instructions for execution by the processor 212.

The file upload apparatus 104 may, in some embodiments, be embodied in various devices as described above. However, in some embodiments, the file upload apparatus 104 may be embodied as a chip or chip set. In other words, the file upload apparatus 104 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The file upload apparatus 104 may therefore, in some cases, be configured to implement an embodiment of the present invention on a single chip or as a single “system on a chip.” As such, in some cases, a chip or chipset may constitute means for performing one or more operations for providing the functionalities described herein.

The processor 212 may be embodied in a number of different ways. For example, the processor 212 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 212 may include one or more processing cores configured to perform independently. A multi-core processor may enable multiprocessing within a single physical package. Additionally or alternatively, the processor 212 may include one or more processors configured in tandem via the bus to enable independent execution of instructions, pipelining and/or multithreading.

In an example embodiment, the processor 212 may be configured to execute instructions stored in the memory device 214 or otherwise accessible to the processor 212. Alternatively or additionally, the processor 212 may be configured to execute hard coded functionality. As such, whether configured by hardware or software methods, or by a combination thereof, the processor 212 may represent an entity (e.g., physically embodied in circuitry) capable of performing operations according to an embodiment of the present invention while configured accordingly. Thus, for example, when the processor 212 is embodied as an ASIC, FPGA or the like, the processor 212 may be specifically configured hardware for conducting the operations described herein. Alternatively, as another example, when the processor 212 is embodied as an executor of software instructions, the instructions may specifically configure the processor 212 to perform the algorithms and/or operations described herein when the instructions are executed. However, in some cases, the processor 212 may be a processor of a specific device (e.g., a mobile terminal or network entity) configured to employ an embodiment of the present invention by further configuration of the processor 212 by instructions for performing the algorithms and/or operations described herein. The processor 212 may include, among other things, a clock, an arithmetic logic unit (ALU) and logic gates configured to support operation of the processor 212.

In some example embodiments, the processor 212 may be embodied as, include, or otherwise control an upload scheduler 220. As such, the upload scheduler 220 may be embodied as various means, such as circuitry, hardware, a computer program product comprising computer readable program instructions stored on a computer readable medium (for example, the memory 214) and executed by a processing device (for example, the processor 212), or some combination thereof. Upload scheduler 220 may be capable of communication with one or more of the processor 212, memory 214, user interface 216, and communication interface 218 to access, receive, and/or send data as may be needed to perform one or more of the functionalities of the upload scheduler 220 as described herein.

Meanwhile, communication interface 218 may be any means such as a device or circuitry embodied in either hardware or a combination of hardware and software that is configured to receive and/or transmit data from/to a network and/or any other device or module in communication with the file upload apparatus 104. In this regard, the communication interface 218 may include, for example, an antenna (or multiple antennas) and supporting hardware and/or software for enabling communications with a wireless communication network. Additionally or alternatively, the communication interface 218 may include the circuitry for interacting with the antenna(s) to cause transmission of signals via the antenna(s) or to handle receipt of signals received via the antenna(s). In some environments, the communication interface 218 may alternatively or also support wired communication. As such, for example, the communication interface 218 may include a communication modem and/or other hardware/software for supporting communication via cable, digital subscriber line (DSL), universal serial bus (USB) or other mechanisms. In this regard, communication interface 218 may serve as a mechanism by which to upload data to network 100, user terminal 110, or the like. Communication interface 218 may receive data to be subsequently uploaded to network 100, user terminal 110, or the like. Additionally or alternatively, communication interface 218 may receive information regarding access points, position data, personal preferences, and/or any other information to be used by the upload scheduler 220.

In some embodiments, such as instances in which the file upload apparatus 104 is embodied by a user device, the file upload apparatus 104 may include a user interface 216 that may, in turn, be in communication with the processor 212 to receive an indication of a user input and/or to cause provision of an audible, visual, mechanical or other output to the user. As such, the user interface 216 may include, for example, a keyboard, a mouse, a joystick, a display, a touch screen(s), touch areas, soft keys, a microphone, a speaker, or other input/output mechanisms. Alternatively or additionally, the processor 212 may comprise user interface circuitry configured to control at least some functions of one or more user interface elements such as, for example, a speaker, ringer, microphone, display, and/or the like. The processor 212 and/or user interface circuitry comprising the processor 212 may be configured to control one or more functions of one or more user interface elements through computer program instructions (e.g., software and/or firmware) stored on a memory accessible to the processor 212 (e.g., memory device 214, and/or the like). Regardless of implementation, a user interface may accept any user input, such as, for example, data to be captured for subsequent uploading. Alternatively or additionally, a user interface may be used to receive personal preferences with respect to uploading, to be described in further detail hereinafter.

In some embodiments, such as instances in which the file upload apparatus 104 is embodied by a device, such as, for example, a smart phone or other mobile device, the file upload apparatus 104 may include a camera 224, audio recorder 226, and/or a global positioning system (GPS) 228. The processor 212 may be configured to control at least some functions of the camera 224, audio recorder 226, and/or GPS 228. The camera 224 may capture still and/or video images, while the audio recorder may capture audio data, that may or may not be recorded simultaneously along with video images. Any such data, or the like, may be stored on memory 214, or streamed via communication interface 218 to network 100. It should be appreciated that camera 224 and audio recorder 226 are example components for capturing data to be subsequently uploaded by file upload apparatus 104, and any other data capturing device or component may be used for capturing such data. Additionally or alternatively, data for uploading may be provided by memory 214, via communication interface 218, via user interface 216, and/or the like.

The processor 212 may be configured to control at least some of the functions of GPS 228. GPS 228 may be used to capture position data of the file upload apparatus 104. The GPS 228 may be controlled at least in part by processor 212, and captured position data may be stored on memory 214. GPS 228 may track the movement of the file upload apparatus 104 with respect to any number of access points and/or GPS 228 may track the movement of the file upload apparatus without regard to other reference points.

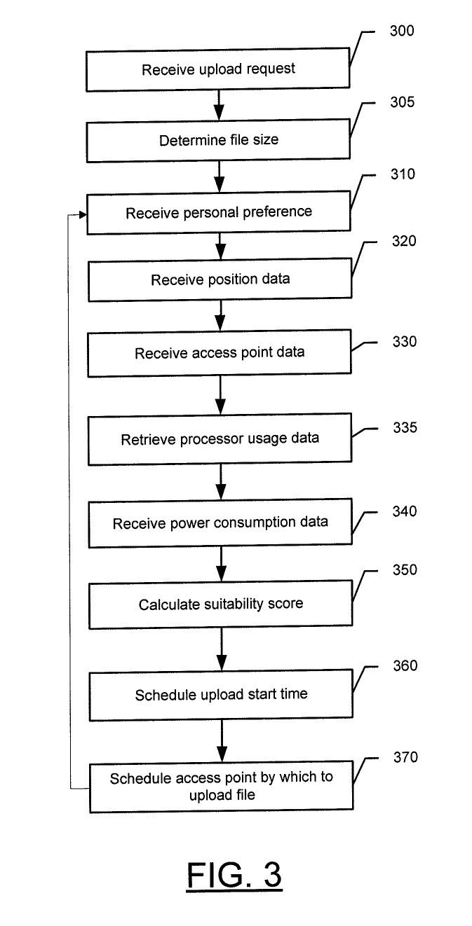

FIG. 3 is a flowchart showing operations to schedule a file upload according to some example embodiments. At operation 300, the file upload apparatus 104 may receive a request to upload a file. The file upload apparatus 104 may include various means for receiving the request to upload a file in that such a request may be received from a user via user interface 216, or generated, for example, by processor 212, such as in an instance where a data capture has completed and the upload scheduler 220 is configured to initiate an upload request upon completion. An upload request may include indication of a file(s) to be uploaded, an indication of a destination, such as file storage apparatus 120, and/or an indication of priority for uploading. At operation 305, the file upload apparatus 104 may determine the file size of the file to be uploaded, so that the file size may be factored into any subsequent suitability score calculations.

In some embodiments, upload scheduler 220 may perform any one or more of operations 310-350. Operations 310-350 may be performed in any order, in any combination, and may be repeated any number of times. Additionally, the means for performing operations 310-350 may include the upload scheduler 220 or, more particularly, the processor 212. Any or all of the information gathered and/or accessed in operations 310-350 may be used subsequently by the upload scheduler 220 to schedule the upload.

In some embodiments, at operation 310, upload scheduler 220 may receive personal preferences with respect to upload scheduling. The personal preferences may be retrieved from memory 214, provided via user interface 216, and/or the like. Personal preferences may include any indications that may be used by the upload scheduler 220 to schedule an upload. For example, a personal preference may include an indication of upload priority by file type and/or size. A user may prefer to upload smaller files prior to larger files as to not impede the uploading of smaller files. Personal preferences may also include a file size threshold, and in instances where a file is larger than the specified threshold, upload scheduler 220 may delay the start time of the upload until another event occurs, such as, for example, the file upload apparatus 104 is connected directly to a user terminal 110, or the like, for uploading via direct wire line, or, the file upload apparatus 104 becomes directly connected to a power source for charging, so as to not deplete battery life prior to upload completion. Similarly, user preferences may indicate a high priority for conserving battery power, causing the upload scheduler to delay an upload start time until a specific level of power is acquired. Additionally or alternatively, a user may prefer files to be uploaded as soon as possible, regardless of other factors. In some embodiments, users may indicate a preferred access point by which to upload their data, and/or times of day, such as at low network usage times, to begin an upload. According to some embodiments, a user may indicate preferences based on specific applications. For example, a user may indicate to upload a video to multiple social media sites, and their personal preferences may indicate that uploading to a specific site should take priority over uploading to another site.

The above examples of personal preferences are intended to be non-limiting and it should be appreciated that personal preferences may include any indication that affects the scheduling of file uploads. The personal preferences may be retrieved as a part of an initial setup, stored on memory 214, for example, and retrieved by the upload scheduler 220. Additionally or alternatively, personal preferences may be indicated on an individual basis, such as, for example, in conjunction with an upload request.

In some embodiments, at operation 320, upload scheduler 220 may receive position data, such as that captured by GPS 228. Such position data may be used by the upload scheduler 220 to determine an upload start time and access point by which to upload data. For example, if upload scheduler 220 determines file upload apparatus 104 is moving at a steady rate, such as in situations in which a user is riding in a moving vehicle, the upload scheduler may delay the upload start time, and/or select access point(s) accordingly. Position data may be obtained from additional or alternative sources than GPS 228. For example, upload scheduler 220 may access calendar information, such as that stored on memory 212. The upload scheduler 220 may use the data to determine an expected time of stay and to optimize the scheduling of file uploads based on the data.

According to some embodiments, at operation 330, the upload scheduler 220 may receive access point data. In this regard, access point data may comprise any information about access points that may be used by upload scheduler 220 to schedule the start time or access point(s) to be used. For example, access point data may include commercial information, such as upload performance history for a specific access point from the file upload apparatus 104, and/or other apparatuses. In this regard, the upload scheduler 220 may access an upload performance plot for access points that may be stored, for example, on memory 214. The commercial information may also comprise data charges associated with uploads to specific access points. Additionally or alternatively, the upload scheduler 220 may retrieve information indicating the signal strength of potential access point(s) by which to upload files and/or reliability data based on previous uploads, such as information depicting the signal strength of an access point over time. As such, the upload scheduler 220 may avoid scheduling an upload via an error prone network.

In some embodiments, retrieving access point data may comprise retrieving information indicating real-time use or near real-time use of an access point(s) including but not limited to available bandwidth. For example, access point(s) in close proximity to major public events may be affected by a higher than average number of users uploading files or otherwise monopolizing network bandwidth. In instances such as these, the upload scheduler 220 may use such information to delay the start time of an upload and/or identify an alternative access point by which to upload a file. Any such access point information may be stored locally, such as, for example, on memory 214, and accessed by processor 212. Additionally or alternatively, it may be received via communication interface 218.

At operation 335, according to some embodiments, upload scheduler 220 may receive processor usage data. Processor usage data may comprise past usage data with respect to file uploads and/or current processor usage data for other applications running on file upload apparatus 104. Processor usage data may be used in conjunction with personal preferences to enable the upload scheduler 220 to determine whether or not a file upload should begin in an instance where a user has indicated priority be given to an application which is currently running and is demanding processor capacity. In this regard, the upload scheduler 220 may delay the upload start time if it is determined uploading the file may affect the performance of another application.

In some embodiments, at operation 340, the upload scheduler 220 may receive power consumption data that may be specific to file upload apparatus 104 and/or other apparatuses. Tracking past power consumption of the apparatus 104 may be particularly beneficial in predicting future power use in uploading files. Power consumption data may comprise data indicating remaining battery life and/or the rate of power usage with respect to various functions of the processor 212, file upload scheduler 220, communication interface 218, and/or any other component. Such data may be stored on memory 214 or accessed via communication interface 218. The data may be used by the upload scheduler 220 to determine whether or not sufficient battery power remains to complete an upload, or keep the power level above a specified threshold in order to allow for other features of apparatus 104 to be utilized. As such, the power consumption data may be used by the upload scheduler 220 to delay the start of an upload in order to conserve battery power. Additionally or alternatively, upload scheduler 220 may determine whether there is not sufficient power to upload a specific file, such as a large video file, but that there is a sufficient power to upload a smaller file, such as an image, and may adjust the file upload start times accordingly.

According to some embodiments, at operation 350, upload scheduler 220 may use any piece or combination of the information received in operations 310-340, and/or any additional information to calculate a suitability score for a particular access point. Calculating a suitability score may take into account the size of the file to upload and may also comprise assigning various weights to each type of data. Weights may be stored on memory 212, and may be provided by upload scheduler 220 and/or derived from personal preferences. For example, battery conservation may be an important priority for some users and may be assigned a weight of 1. A user may indicate that the need for a particular application to remain running is equally as important as battery conservation, so that application may be assigned a weight of 1. The same user may indicate that file types should be given a weight of 0.5, and access point preference a weight of 0.25. Regardless of configuration, upload scheduler 220 may aim to rate the access point(s) most suitable to upload the file, based on personal preferences and/or any other data, with the highest suitability score. In some embodiments upload scheduler 220 may not schedule an upload via a particular access point if the access point's suitability score falls below a certain threshold.

In some embodiments, at operation 360, upload scheduler 220 may utilize any combination of information received in operations 310-350, and/or any other information available to schedule an upload. As such, the upload scheduler 220 may include means, such as the processor 212, for scheduling an upload. As described above, different scenarios may cause the file upload scheduler 220 to start an upload immediately, or delay the start time a certain amount of time or indefinitely until a specific event occurs. Similarly, at operation 370, the upload scheduler 220, according to some embodiments, may schedule an access point(s) by which to upload requested files. The upload schedule may therefore include means, such as the processor 212, for scheduling the access point(s) by which to upload the requested files. The upload scheduler 220 may use the suitability score, any combination of information received in operations 310-350, and/or other available information to schedule the access point(s) by which to upload the files. For example, an access point with the highest suitability score may be selected to utilize in the file upload. In some embodiments, the upload scheduler 220 may provide multiple access points by which to upload a file. Additionally or alternatively, the upload scheduler 220 may schedule a primary access point(s) and secondary access point(s), the secondary access point being utilized in the event the upload to a primary access point does not upload at a desired rate. A secondary access point may be selected by choosing, for example, an access point with the second highest suitability score. The upload scheduler 220 may, in some embodiments, continually monitor any data and/or recalculate a suitability score as an upload progresses. As such, in an instance where the upload scheduler 220 detected any discontinuity, abnormality, or otherwise slow upload rate, the upload scheduler 220 may determine another access point is more suitable for the upload, and switch to upload a file by a different access point. Such a change may be performed by the upload scheduler 220 or an upload scheduler switch implemented on the upload scheduler.

As described above, FIG. 3 illustrates a flowchart of an apparatus, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device 214 of a file upload apparatus 104 employing an embodiment of the present invention and executed by a processor 212. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving at least one request to upload a file;
calculating, by a processor, a suitability score associated with at least one network access point; and
scheduling at least one of an upload start time or the network access point by which to upload the file, the scheduling of the network access point being based on, at least in part, the suitability score.

2. A method according to claim 1, further comprising receiving indication of personal preferences, and wherein the scheduling is based on, at least in part, the personal preferences.

3. A method according to claim 1, further comprising receiving position data, and wherein the scheduling is based on, at least in part, the position data.

4. A method according to claim 1, further comprising receiving network access point data, and wherein the scheduling is based on, at least in part, the network access point data.

5. A method according to claim 1, further comprising receiving power consumption data, and wherein the scheduling is based on, at least in part, the power consumption data.

6. A method according to claim 1 wherein the scheduling comprises delaying the upload start time until receipt of an indication of direct connection by wire line to a device.

7. A method according to claim 1, further comprising receiving central processing usage data, and wherein the scheduling is based on, at least in part, the central processing usage data.

8. A method according to claim 1, further comprising:
monitoring upload progress;
recalculating the suitability score; and
changing the scheduling of the network access point by which to upload the file.

9. An apparatus comprising at least one processor and at least one memory including computer program code, the at least one memory and the computer program code configured to, with the processor, cause the apparatus to at least:
receive at least one request to upload a file;
calculate a suitability score associated with at least one network access point; and
schedule at least one of an upload start time or the network access point by which to upload the file, the scheduling of the network access point being based on, at least in part, the suitability score.

10. An apparatus according to claim 9 wherein the at least one memory and the computer program code are further configured to, with the processor, cause the apparatus to receive indication of personal preferences, and wherein the scheduling is based on, at least in part, the personal preferences.

11. An apparatus according to claim 9 wherein the at least one memory and the computer program code are further configured to, with the processor, cause the apparatus to receive position data, and wherein the scheduling is based on, at least in part, the position data.

12. An apparatus according to claim 9 wherein the at least one memory and the computer program code are further configured to, with the processor, cause the apparatus to receive network access point data, and wherein the scheduling is based on, at least in part, the network access point data.

13. An apparatus according to claim 9 wherein the at least one memory and the computer program code are further configured to, with the processor, cause the apparatus to receive power consumption data, and wherein the scheduling is based on, at least in part, the power consumption data.

14. An apparatus according to claim 9 wherein the scheduling comprises delaying the upload start time until receipt of an indication of direct connection by wire line to a device.

15. An apparatus according to claim 9 wherein the at least one memory and the computer program code are further configured to, with the processor, cause the apparatus to receive central processing unit data, and wherein the scheduling is based on, at least in part, the central processing data.

16. A computer program product comprising at least one non-transitory computer-readable storage medium having computer-executable program code instructions stored therein, the computer-executable program code instructions comprising program code instructions to:
receive at least one request to upload a file;
calculate a suitability score associated with at least one network access point; and
schedule at least one of an upload start time or the network access point by which to upload the file, the scheduling of the network access point being based on, at least in part, the suitability score.

17. A computer program product according to claim 15 wherein the computer-executable program code instructions comprise program code instructions to receive indication of personal preferences, and wherein the scheduling is based on, at least in part, the personal preferences.

18. A computer program product according to claim 15 wherein the computer-executable program code instructions comprise program code instructions to receive position data, and wherein the scheduling is based on, at least in part, the position data.

19. A computer program product according to claim 15 wherein the computer-executable program code instructions comprise program code instructions to receive network access point data, and wherein the scheduling is based on, at least in part, the network access point data.

20. A computer program product according to claim 15 wherein the computer-executable program code instructions comprise program code instructions to receive power consumption data, and wherein the scheduling is based on, at least in part, the power consumption data.
